(19) United States
(12) Patent Application Publication
(10) Pub. No.: US 2011/0179757 A1
(43) Pub. Date: Jul. 28, 2011

(54) Lightweight battery-driven air-supported vegetation trimmer

(76) Inventors: N. Scott-Stanbridge, Buckingham (GB); Judy A. Sutton-Grant, Toccoa, GA (US); Nigel S. Grant, Coral Gables, FL (US)

(21) Appl. No.: 12/930,065

(22) Filed: Dec. 27, 2010

Related U.S. Application Data
(60) Provisional application No. 61/290,183, filed on Dec. 25, 2009.

(51) Int. Cl. A01D 34/835; A01D 34/00

(52) U.S. Cl. 56/12.8; 56/320.1

(57) ABSTRACT

A lightweight hand held vegetation trimmer powered by an onboard battery, or alternatively available in a version powered by 120 volt mains power. A battery pack powers an electric motor to generate a rotary output and a cutting line adapted to be rotably driven by a line support structure, all enclosed within a round or elliptical shaped hood. By introducing an upwards facing impeller driven by the same electric motor within the internal chamber under the hood structure, the trimmer is floated on a cushion of air, to carry the weight of the cutting head to reduce operator fatigue and to maintain a continuously horizontal cutting position for the cutting element.

### CROSS REFERENCE TO RELATED APPLICATIONS

The present application is a continuation application of United States provisional patent application, Ser. No. 61/290,183, filed Dec. 25, 2009, for ULTRA LIGHTWEIGHT BATTERY DRIVEN HOVER LAWNMOWER, by N. Scott-Stanbridge, included by reference herein and for which benefit of the priority date is hereby claimed.

### FEDERALLY SPONSORED RESEARCH

Not Applicable

### SEQUENCE LISTING

Not Applicable

### BACKGROUND-FIELD

The present application relates to lawn trimmers and mowers and, more particularly, to a lightweight air-supported tool that is easy to store, carry and use without regard for the operator's age or strength. In addition, the application is submitted as a Green Technology innovation with a low carbon footprint.

### BACKGROUND OF THE INVENTION

### References

http://www.peoplepoweredmachines.com/faq-environment.htm—Cleaner Air: Gas Mower Pollution Facts. EPA Statistics.
http://www.flymo.com—range of mowers and trimmers not available in the United States. Despite their pioneering work in hovercraft and an extensive product line, the Flymo lineup does not include a battery-powered, air-supported trimmer or mower. It also does not support an air-supported trimmer of any kind.
http://www.flymo.co.uk/node559.aspx—“As from Jan. 1, 1995, any manufacturer of products with any form of metal cutters must be able to stop the blade within 3 seconds. This is mandatory. If the product is built and designed to take plastic cutters, it will not be fitted with a brake on the motor, therefore it is illegal to fit a metal blade.” EU Regulations.
http://www.cpsc.gov. Consumer Product Safety Commission issued a safety standard for powered rotary lawnmowers on Feb. 26, 1979, which requires that all such mowers manufactured after Dec. 31, 1981, be equipped with a deadman control and a blade control system which will accomplish the following objectives: first, prevent the blade from rotating unless the operator activates a blade rotation control; secondly, require continuous contact with the blade rotation control in order that the blade continue to be driven; and thirdly, the blade rotation control must cause the blade to stop within 3 seconds after release. US Regulations.
http://www.neutonpower.com—heavy duty battery-driven mowers and handheld battery-operated trimmer, but no anticipation of air-supported devices.
www.hovertrimmer.com—“Hover Trimmer Kit” from Irish manufacturer. This device is included in the interests of full disclosure but it fails our test for comparison. It is an add-on kit for a gas-powered trimmer, using metal blades to produce a cushion of air and simultaneously cut grass. The cost outside Ireland exceeds $200 for the kit alone and we believe it fails the EU and US regulations described herein for 3 second automatic braking for a device with metal blades (see Flymo and US Consumer Product Safety Commission references above). In addition, although it claims to be patent protected, we can discover no patent, nor will the manufacturer quote us a patent number. The inventors consider this is an interesting concept but discount the use of a gas-powered kit with sharpened metal blades. It does not appear to have met with commercial success.
Popular Mechanics November 2010 edition. The November 2010 edition of Popular Mechanics Magazine cites the HSA 65 36-volt lithium-ion battery trimmer from Stihl as one of the year's 10 most transformative products. Page 78 of the magazine quotes: “Two-stroke, gas-powered tools are famously polluting and loud, but electric variants typically lack the power or durability to really be practical.” The innovative 36-volt lithium-ion AP 80 battery from Stihl used in this device represents a breakthrough in battery power and run time. No reference is made in the Stihl literature or website to the opportunity to deploy this power module into an air-supported trimmer implement.
Popular Mechanics December 2010 edition. Page 36. Under Section entitled Wish List, the magazine's annual guide to the most wanted tech, tools etc “Mile for mile, a gas-powered lawnmower produces exponentially more pollution than a car.” “Mow Green.” Extolling the virtues and desirability of the Neuton CE5 Duracell-Powered Lawnmower, despite its price tag of $400-500, yet it fails to even suggest that a similar technology be applied to trimmer machines, a high percentage of which are two-stroke gas-operated, the worst kind of polluters.

### BACKGROUND

### Description of Problem

Line trimmers of the kind which are often used for trimming the edges of lawn or for trimming weed or indeed for trimming grass such as are often found on the sides of roads or highways include a motor (usually an internal combustion motor) which is engaged to the end of a shaft. The motor will drive a shaft which at the other end has attached the cutting element. A cutting element may for example be a fixed blade or alternatively be a nylon string which is rotationally driven via the shaft by the motor. The cutting elements can be exposed to the grass or weed to cut the grass or weed at the desired height. The unit will normally include a handle and speed controller to control the rpm's of the motor. For heavier units the line trimmer may also include a support harness which can be slung about the body of a user to provide support by the user to the weight of the unit. Whilst some versions of a line trimmer will provide a guard presenting protection to the cutting elements in a direction of the body of the user, such a guard merely serves the purpose of providing protection, and then only in one direction or arc of directions.

A standard line trimmer however has difficulty in being used for cutting lawn to a desired level. Since the cutting elements can be held at a varying height above the ground, careful control is needed to be exercised by the user to achieve a cut of grass at a consistent height across the entire area of the lawn. This can be difficult to achieve and, if the line trimmer is held at the wrong angle, can result in gouging of the lawn thereby creating an uneven look to the height of the cut grass. It is appreciated that lawn mowers can achieve a consistent height in the cutting of grass, mainly because they run on 4 wheels. However lawn mowers are relatively large tools and in certain applications, particularly in residential or inner city locations where the amount of grass that is to be cut is relatively minimal, it may not be desirable or practical to use a lawn mower for cutting the grass.

Portable rotary-head lawn trimmers have become a commonplace item for use in lawn maintenance. Such trimmers typically consist of a rotary motor or engine, the driveshaft of which is coupled to a rotary cutting head by means of an elongated rotating shaft or cable. These devices perform a useful function by allowing the operator of the trimmer to cut grass, weeds, and seedlings in areas which may not be accessible by conventional lawn mowers. However, as hand-carried devices, these trimmers require that the operator manipulate and maneuver the trimmer while supporting its weight manually or with the aid of a shoulder strap from which the trimmer is suspended. Carrying and manually maneuvering the trimmer requires a level of physical exertion that may be stressful and produce fatigue for the operator. Because of the above “juggling' of the tool, and because there is nothing to keep it in a perfect horizontal plane above the grass, the cut is uneven and unsatisfactory.

The invention described herein provides a means for utilizing a lawn trimmer without having to carry its weight. Various lawn trimmer carriage devices exist in a relatively crowded field of prior art, but there is still an unmet need for a design that allows the use of a lawn trimmer to duplicate the major functions achievable by manual lawn trimmer operation, and to do so with relative ease and economy.

The present invention relates to a battery powered vegetation trimmer of the type in which a rotating line, string or wire (hereafter referred to as line) is used to cut vegetation, particularly grass. The innovative aspect of this invention is the combination of currently known features used in trimmers together with the deployment of a cushion of pressurized air beneath the deck to create an air-supported (“hover”) cutting head.

In known battery powered vegetation trimmers of this type, a battery pack powers an electric motor. A rotary output of the electric motor directly drives a line support structure in a rotatable manner. The line support structure may support up to four lines. The line is supported by the line support structure so that an end section of the line extends from the structure. As the structure rotates, the end section of the line is rotated and will cut any light vegetation or grass which comes into the path of the line. A small cutting device may be located within the structure to trim each line to the requisite length as it rotates.

Until now, vegetation trimmers have been designed so that the weight of the trimmer is supported by the user. The height, orientation and direction of movement of the cutting head of the trimmer, when in use, is determined by the way in which the user holds and moves the trimmer. As a vegetation trimmer has to be supported by the user, it has been important to keep the weight of the trimmer to a minimum. This has been achieved by minimizing the weight of the various component parts of the vegetation trimmer, for example, the weight of the battery or motor.

Vegetation trimmers have traditionally been segregated into lawn mowers, typically four-wheeled machines weighing upwards of 40 pounds and grass trimmers that weigh in the region of 10-20 pounds and are designed to tidy up parts of the lawn that are not cut by the mower; around the paths, trees, etc. This application refers strictly to the latter type of hand-held trimmer which is normally designated by the industry as a “trimmer,” and never a “mower.” In other English-speaking parts of the world, this may be called a “strimmer.”

The inventors have noted in their travels across Europe and the USA many older and less able persons trying to use their gas and electric trimmers as a makeshift lawn mower. The reasons such people try to do this are multifarious but they likely include the fact that a trimmer weighs a lot less than a mower and is usually a “single stick” system—and for these reasons easier for less capable people to carry and operate. In addition, many people do not have large lawns and while they are trimming around their lawn, they consider it worthwhile trying to cut the lawn itself while they have taken the trouble to get the trimmer implement out and in operation.

Other reasons that support the use of trimmers by less able persons are the availability of cordless and especially battery-driven trimmers. Such a tool is ideal for people with quarter-acre or smaller lawns who do not want the headache, backache or hassle associated with gasoline powered mowers. Elderly homeowners detest arm-yanking pull-starts, messing with gas and oil, and struggling with a heavy lawn mower. A battery-powered lightweight trimmer starts instantly with a gentle squeeze of the handlebar and never needs a tune-up. A single-stick tool can potentially be pushed and pulled around the lawn like a vacuum cleaner.

The elderly homeowner is an important user of grass cutting tools. According to the US Census, estimates for 2008 place the US population at 300 million. Of those, 31 million people are over 65 and 70 million are 55 years and older. This graying population continues to grow, bolstered by advances in medicine and public health. By 2011 the U.S. Baby Boomer population, the generation born after 1946, will exceed 80 million and the retiring Baby Boomers will significantly increase the population over 65 in coming years, which translates to a significant market demand for this invention.

The problems described above were never recognized in lawn mower prior art although it was seen in the trimmer field and numerous patents exist that attempt to handle the problem of fatigue; the challenge of catering to this large mass of the population who are not strong enough to handle 40 pound mowing machines, yet who wish to keep their garden up; who do not like gas-powered lawnmowers; or who cannot afford to have a commercial lawn service cut their grass each week—with gas-operated, noisy and polluting equipment.

The major objective considered in this application is how to produce a cordless lawn tool that can be used essentially as a trimmer but also doubles as an informal mower. The problems inherent in this treatment include questions of weight, motive power, cost, format, cutting design, and operator safety. Although the fields of mowers and trimmers traditionally employ different technology, motive power and cutting techniques, this part of the application means to include both fields for review and comparison purposes.

One further consideration to bear in mind is that the trend in lawn cutting is strictly away from picking up grass clippings, and therefore current machines are aimed at mulching grass as it is cut. Municipalities across the United States and Canada are now refusing to collect grass clippings because of reduced availability of landfill and other problems with including such waste in the fill. Accordingly, this application is for a tool that mulches grass as it is cut and the inventors do not compare this application to prior art that focuses on enhancements aimed at collecting grass in the cutting implement.

Weight

The majority of power mowers weigh upwards of 40 pounds and this can constitute a major obstacle for older people to lift over garden obstacles such as garden paths, brick edging—and moving from one part of the lawn to another. Battery powered mowers typically weigh even more than internal combustion mowers. The Neuton 36 volt battery mower, for example, weighs 88 pounds and a similar Black & Decker model weighs 77 pounds. This excessive weight plus the “pram handle” design of the typical mower without a ready carrying point at the center of gravity creates a challenge for their personal use by homeowners of limited physical abilities, especially the elderly or handicapped.

The Neuton system now includes a battery powered trimmer that weighs much less, using a nickel-cadmium battery, but it does not anticipate or suggest an air-supported trimmer cutting head.

On the other hand, lawn trimmers typically weigh quite a lot less. Battery and 120 volt mains-driven trimmers weigh in the region of 10 pounds and gas-operated machines closer to 20 pounds. They are also in the “single stick” format, and are for these reasons an attractive lawn tool for many homeowners.

There is a comparative trade-off in weight considerations between the models. The exemplary alternative embodiment of a pram handle design of the operating prototype, as illustrated in FIG. 2, using 120 volt mains power connected to a steel magneto coil alternating current motor involves little weight drag from the 100 foot length of power cord. The steel motor does, however, weigh some 3½ pounds, bringing the total weight of the prototype to just less than 10 pounds.

The version that is the preferred embodiment of this application, as shown in FIG. 1, a single stick comprising a lithium ion battery in the handle weighing 2½ pounds and a permanent magnet direct current electric motor weighing around 12 ounces, enables the overall weight of the trimmer to be kept around 10 pounds, which is a reasonable level to enable a user to easily carry and operate the trimmer.

Alternatively, the pram handle design of FIG. 2 can be modified to enable a lithium ion battery to be placed above the dome and under the protective hood covering as shown (8), with the motor exchanged for the direct current motor, and this would produce a similar result. At a speed of 7500 rpm, the motor will raise either machine to the requisite height for floating and also trim grass.

It should be borne in mind that the cutting head has virtually zero weight because of the air-supported system, so the burden of weight falls almost entirely on the handle. This means, in comparing the models, that the pram handle will be lighter to hold, but potentially more cumbersome to manage because of the trailing power cord.

Motive Power

Driving power is a serious challenge that this application seeks to correct. Garden equipment using internal combustion engines, which have had unregulated emissions until very recently, emit high levels of carbon monoxide, volatile organic compounds and nitrogen oxides, producing up to 5% of the nation's air pollution and a good deal more in metropolitan areas. New exhaust emissions standards will not take effect until 2011 or 2012, and will not affect lawn mowers or trimmers already in existence. According to the Environmental Protection Agency, Americans burn 800 million gallons of gas each year trimming their lawns. One gas mower running for an hour emits the same amount of pollutants as eight new cars driving at 55 mph for the same amount of time, according to the Union of Concerned Scientists.

The EPA states that 17 million gallons of fuel, mostly gasoline, are spilled each year while refueling lawn equipment. That's more than all the oil spilled by the Exxon Valdez in the Gulf of Alaska. In addition to groundwater contamination, spilled fuel that evaporates into the air and volatile organic compounds spit out by small engines make smog-forming ozone when cooked by heat and sunlight.

The California government reports that 25 percent of the air pollution in that state is generated by two-stroke engines, primarily lawn mowers and trimmers. Americans, with more than 60 million lawn owners, now devote about 40,000 square miles to lawns, more than that used for wheat, corn and tobacco combined. They mow some 31 million acres of lawn every year, using 300 million gallons of gas. Turf is the largest irrigated crop in America and 5,000 new acres are planted daily. Lawn care is a $40 billion industry.

Switching to an electric lawn mower or trimmer is one of the cheapest and most effective ways to reduce impact on the planet. Electric mowers don't totally eliminate pollution, however emissions from the electric industry are more regulated and they save on gas spills and gas refinery and transportation. To achieve a net environmental savings from switching from gas to electric mowers depends on the efficiency of the power plant from where the electricity originates.

The government of Canada and many US cities and states have instigated subsidized programs where gas mowers can be exchanged for battery operated mowers at a discounted price. Battery-powered cordless mowers are quieter than regular gas mowers and need little maintenance. Gas mowers require regular maintenance and cleaning of the engine with knowledge of carburetor and choke controls, much of which is beyond the skill and interest of many users. Battery powered tools use less than 2 cents worth of electricity to recharge.

Switching all gas powered mowers and trimmers in the US to electric vegetation trimmers would eliminate the equivalent pollution generated by 1.7 million cars driving 11,000 miles, just in one year. The fuel contained in 2,800 tanker trucks would not be spilled and 3 million tons of greenhouse gases would not be released into the atmosphere.

In addition to the above disadvantages, gas-operated devices are started by pulling hard on a starting cord, an operation that is not suited to elderly or infirm operators.

It stands to reason, therefore, that an application that makes a power trimmer available in a battery-driven format, but with a lower weight factor, say in the region of 10 pounds, together with a single stick format, would provide a realistic solution to the above problems of pollution and ease of operation. There are, however, further improvements to make this tool truly usable to the elderly user—and those enhancements make this application novel.

The inventors submit that the attractiveness and inexpensive nature of this application will cause a large number of users of gas-operated trimmers and mowers to abandon their machines in favor of this invention, creating a highly positive move to Green Technology.

A problem with known battery powered vegetation trimmers is achieving an acceptable run time before the battery requires recharging. In order to achieve acceptable run times large (and thus heavy) batteries or relatively expensive batteries have had to be used, neither of which are ideal. Therefore, when designing a battery powered vegetation trimmer, there is always a balance between run time and either weight or expense.

Recent discoveries make all the difference. The November 2010 edition of Popular Mechanics Magazine cites the HSA 65 36-volt lithium-ion battery trimmer from Stihl as one of the year's 10 most transformative products. Page 78 of the magazine quotes: “Two-stroke, gas-powered tools are famously polluting and loud, but electric variants typically lack the power or durability to really be practical.” The innovative 36-volt lithium-ion AP 80 battery from Stihl used in this device represents a breakthrough in battery power and run time. At a weight of only 2.5 pounds, and compact enough to fit into the handle of a cordless single stick trimmer, it is the ideal motive power concept for this application. In comparison, the battery used in the Neuton 26855 36-volt battery for the cordless mower mentioned above weighs 23 pounds and has dimensions that preclude its use in a hand-held trimmer.

Until the time of this application it has been difficult to provide sufficient battery power to drive an air-floated device of any kind. (See information in this application regarding Flymo). However, such breakthroughs in technology now make this application possible. We submit that the attractiveness of this invention will cause homeowners to switch from gas-operated trimmers to our invention and thus create a highly positive effect on the ecology. This should not be construed to indicate that the Stihl battery must be used, only that a similar technology may be employed to achieve the results described herein.

The inventors have constructed a working prototype of this application in a pram handle embodiment using 120 volt mains power by assembling lightweight lawn mower parts and installing a 120 volt motor expressly commissioned by them from the Italian Division of the US company that manufactures 240 volt motors for Flymo lawn mowers. This prototype is the only 120 volt mains-driven, air-floated (i.e., hover) trimmer anywhere in the world, according to extensive research made by the inventors. Nonetheless, it is inferior to a battery-driven trimmer because of the challenges inherent in dragging the power cable behind the trimmer.

Cost

The cost of power mowers varies considerably, from a low of around $140 for an entry level gas model, to around $400 and up for a reliable, easy-to-start gas model or a heavy battery model. It should be noted that the typical current entry level gas mower, the $149 Yard Machines model 11A, weighs 65 pounds, too much for an elderly person to lift. This application provides for the construction and sale of a lightweight battery trimmer model in the region of $100 and thus provides an efficient and less expensive answer to market needs.

Format

The design of the handle construction should preferably be of a single stick structure to allow for ease of carrying and operation. At present we believe this embodiment operates most efficiently, but the other embodiments are also satisfactory. The current invention does allow for a pram handle design as an alternative embodiment that is equally easy to carry with one hand, although it requires both hands to operate. The battery-driven single stick model, with an air-floated cutting head, would be easy to float around the lawn and will cut grass and glide as easily as a vacuum cleaner slides over carpet.

Cutting Design

The vegetation cutting method of the application is based on a horizontally mounted, upwards-facing impeller below which is affixed a cutting system using line or lines, all within a hood that is thus supported on a cushion of air. This cushion of air entirely supports the cutting head above the ground in a correct horizontal plane and takes all the weight off the operator. The problems with the use of current trimmers are twofold: the tool has to be held off the ground with the hand that is not holding the handle, causing strain on the shoulder and back, and also it is difficult to hold the tool in an horizontal position for any length of time, causing the cutting head to cut unevenly or even to dig into the lawn.

Operator Safety

Because this tool is designed to suit an elderly population, user protection is a key concern. The prior art is prolix with attempts at solutions of how to provide a safe, efficient and simply constructed rotary head for rotary lawn mowers, edgers, trimmers and the like. Heretofore, the rotary head has often comprised a rotating metal knife blade which is rotated at sufficient speeds to effect cutting of grass, weeds or the like. However, such blades create hazardous conditions in that when they strike certain objects they act upon those objects in a fashion to create and launch dangerous missiles which may strike the operator or individuals in the area of work. A piece of broken cutting blade can become a dangerous missile.

More recently it has been found and generally accepted in North America that a length of flexible non-metallic line or string may be used to cut or trim grass and other light-weight vegetation with reasonable effectiveness. Furthermore, a cutting device of this type possesses a significant safety advantage with respect to the more conventional blade-type cutters, in that it does not cause stones or other solid objects to be discharged in the same dangerous manner, and it is almost completely incapable of causing any significant injury to persons or pets struck by the flailing cutting line.

For these reasons, then, we consider that the use of any metal blades in the trimmer is not to be tolerated. Comment on www.amazon.com: “Now you have heavy duty steel cutting blades that will take off your toes if you don't wear steel toe boots! Best to wear a safety shield as well.” The inventors find that a flexible nylon line with up to 0.130″ diameter is particularly suitable for low grass lawn trimming. For this reason, we do not review patents or articles that depend on metal blades because they are not relevant to this application.

In the European Union, for example, as from Jan. 1, 1995, any manufacturer of garden products with any form of metal cutters must be able to stop the blade within 3 seconds. This is mandatory.

In addition, the use of a completely enclosed hood or cowl, which is necessary to effect the air cushion ground effect, also provides protection against objects that may be thrown up from the trimmer, such as stones, wire, or even snakes! Even a partially open trimmer shield has not been found to be effective against such dangerous flying objects.

### BACKGROUND

### Other Solutions

Lawn trimmers have previously been designed for use by persons with average physical abilities and are fairly easy to operate for short periods by these physically able persons. A need for a trimmer that can perform very well and be operated by persons of limited physical abilities, i.e. elderly and handicapped, has been attempted by several prior art patents.

There are benefits associated with some of the prior art but prior art does not singularly and completely eliminate the many problems that result in the use of such devices, mainly because the general approach is based on a wheeled support structure. The problems encountered are typically: 1) awkward and cumbersome use due to uneven weight distribution and wheel size and location, 2) lack of trim action on both sides and front of device, 3) lack of support of the motor, 4) loss of the automatic feed feature, 5) excessive operator forces required to maneuver the unit and, 6) lack of complete cutting height control.

In a number of circumstances, the weight of such devices has proved to be an impediment to their use and the fact that the devices have been designed to be hand held has also limited their application to a number of trimming jobs such as under large trees and bushes having extensive overhanging foliage, or under fixedly mounted lawn furniture. For long periods of operating time, the devices can be a considerable burden to handle due to their weight and due to the fact that care must be taken to maintain the electric cord in a safe position. Also, where the devices are gas operated, the weight of the motor and fuel can be a critical factor contributing to early fatigue for the user. Additionally, use of these hand held trimmers on certain landscapes can be dangerous, such as, where the terrain is very steep providing difficulty for the operator to maintain a balanced foothold.

The present invention eliminates all of the above problems simultaneously in a manner not disclosed in the prior art. However, in this relatively “crowded” art, there are substantial, innovative, “unobvious” differences between the present invention and the prior art, as brought out more fully below. It is believed that the present invention represents an innovative, substantial advance in the prior art and a valuable contribution to the “useful arts.”

Because this application refers essentially to lawn trimmers, and not mowers per se, the inventors have not included the plethora of lawn mower references that would make this application unreadable and which are, moreover, not germane to this material.

Similarly, since the application argues against the use of grass collection on the grounds stated herein, patents that are essentially related to grass collection have not been included.

Many patents exist relating to lawn trimmers that attempt to solve the problem of fatigue and even cut, including the following:

U.S. Pat. No. 4,389,836 to Lowry, et al., discloses a wheeled platform provided with a centrally located aperture for receiving and supporting the lower portion of housing for a grass trimming device so that the cutting element of the device will extend beneath the platform. This is essentially a four-wheeled trolley onto which a trimmer may be loaded and is hardly usable in practice.

U.S. Pat. No. 4,510,738 to Dunn describes an early air-cushion lawn mower supporting a freely rotatable roller. This device does nothing to freely support the implement without using a secondary wheeled device. It is, in fact, a mower with a support wheel.

U.S. Pat. No. 4,531,350 to Huthmacher discloses a three-wheeled frame support for an electric trimmer which in effect converts it into a lawn mower.

U.S. Pat. No. 4,704,849 to Gilbert describes a lawn trimmer supported by two frame member connected by a yoke, which operates on wheels.

U.S. Pat. No. 4,879,869 to Buckendorf describes a wheeled attachment for a grass trimmer and includes a mounting bar having a wheel at each end, detachably mountable to the grass trimmer to provide control and support for the grass trimmer.

U.S. Pat. No. 4,891,931 to Holland discloses a trimmer wheel kit that is adaptable to support a cutting head assembly wherein the weight to be supported is at the lower end.

U.S. Pat. No. 4,922,694 to Emoto discloses a two-wheeled trimmer support that is adaptable for use with electric trimmers wherein the only weight to support is the cutting head assembly itself. The controllability is limited critically by the point of attachment of the support means and the positioning of the wheels.

U.S. Pat. No. 4,936,886 to Quillan discloses a wheel mounted string trimmer having a wheel support with a pair of wheels mounted on opposite sides thereof and handle bars extending rearwardly from the support.

U.S. Pat. No. 5,048,615 to Feldman discloses a three-wheeled trimmer that utilizes a cutting head that is effective only on one side of the apparatus. The effective weight of the motor is substantially forward of the rear axle which requires operator forces during use similar to those needed to manipulate a lawn mower.

U.S. Pat. No. 5,626,006 to Fricke discloses a dolly for portable weed cutters that includes a frame provided with upper and lower clamp members for engagement with a handle bar of a conventional portable weed cutter for detachably securing the weed cutter to the dolly.

U.S. Pat. No. 5,771,670 to Perry discloses a two-wheeled lawn trimmer, controlled with a handle attached to a frame which receives a conventional gasoline or electric powered rotary lawn trimmer, and claims to provide balanced maneuverability with low operator forces while purportedly providing complete trimming access and cutting height control. However, this device is a heavy-duty machine, unsuitable for the elderly homeowner and does not provide a protective dome for the user. The use of wheels to control the level of the cutting head is clumsy and obviously inferior to an air-supported cutting head.

U.S. Pat. No. 5,836,142 to Maxwell describes a multiple frame wheel attachment connectable to a handheld device, such as a gasoline powered weed trimmer. The wheel attachment has a pair of wheels attached to the ends of an axle and a pair of frame assemblies connecting the axle and wheels to the lawn trimmer

U.S. Pat. No. 5,845,405 to Rosdahl describes a cutting tool for use with a brush cutter, trimmer or like device for cutting thicket, grass and like vegetation with metal blades so angled as to rotate air so that the air will be pressed down towards the ground and therewith causes the tool to hover or lift slightly above the ground surface. This machine is discounted because of its use of metal blades and open hood. Although it appears to be a potentially dangerous device in use, we believe this design has been used in the Irish hover machine referenced above.

U.S. Pat. No. 6,266,950 to Stace describes a hovermower with a deck being pivotable relative to the handle about a first substantially horizontal axis, characterized in that the deck is further pivotable relative to the handle about a second horizontal axis transverse to the first axis. This patent is designed to create more maneuverability in the head of the device. This is not a trimmer and, moreover, is not lightweight or battery-powered. It depends upon a metal blade for cutting and for these reasons we discount its use.

U.S. Pat. No. 6,014,812, continued in U.S. Pat. No. 6,301,788, to Webster discloses a battery powered vegetation trimmer that attempts to handle the problem of operator fatigue in holding up the trimmer head by including a guide structure (“skid”) below the cutting head, to help the user maintain the cutting head at a constant height above the ground (FIG. 2, item 31). Although this feature is a secondary part of this patent, it is hardly effective in creating a weightless and constant positioning of the cutting head.

U.S. Pat. No. 7,100,287 to McCoid describes a lawn trimming device attachable or attached to the power take off end of a line trimmer primary unit to be powered by the line trimmer. This is a kit that depends upon the supply of a basic gas-powered trimmer unit and is not considered apposite in this review. While a fan under the housing is mentioned, the design of the application is not aimed as an air-supported battery-operated device.

U.S. Pat. No. 7,114,316 to Wilkerson describes a rolling lawn trimmer carriage upon which a trimmer is mounted for weight support and maneuverable operation of the trimmer.

EP0515909 to Orthey et al., describes a line trimmer that includes a dependence on a skid-like device (FIG. 1, item 32, shown but not described) to keep the cutting head stable and level.

With regard to the above listed patents and references, the inventors believe that the use of a supporting wheeled device or a simple skid mechanism is not a valid solution or a commercially successful apparatus for the instant problem.

Extensive research has uncovered no battery-operated air-supported trimmers in operation anywhere in the world. Since the air-support process is similar to that also known in hovercraft vehicles, such trimmers and mowers have been investigated.

In North America the only known hover vegetation cutting device on the market is the Allen mower, also sold by Eastman Industries, at a cost of over $800 and with a weight of over 40 pounds. This is a pram handle, gas-operated industrial machine that is started using a pull-handle and it has metal blades. Mainly for commercial use on golf courses, it is not suitable for lightweight residential purposes. The machine does not appear to be covered by a patent. For the reasons outlined above, it does not qualify in the category this application covers.

In the United Kingdom, there are several hover mowers on the market operating on 240 volt mains power but none operated by battery power. Known trimmers operating on battery power, both in the United States and in Europe, are restricted to non-air supported devices.

Since commercializing the hover mower more than 40 years ago Flymo have become a market leader in the design and innovation of unique gardening products. A subsidiary of a Swedish company, Flymo is considered a world expert company in hover mowers.

The only cordless hover mowers in the Flymo range are gas-operated. These heavy-duty, pull-start machines, fall into a similar category to, and with the same disadvantages of, the above Eastman machines. These mowers are so heavy and cumbersome that the company publicly (on their website) recommends the purchase of “transport wheels for improved manoeuvrability in use and easier transportation.”

Flymo has an extensive range of trimmers, including cordless battery-driven tools, but NONE are air-supported cutters and they fall into the same category as those seen in the North American market.

It should be seriously borne in mind that Flymo has not only many years of hover systems experience and expertise, but it also has the mower/trimmer “crossover” background to understand how to take the hover mower technique into a trimmer technology. This it has not done, nor has it applied for patents in that area.

If the invention were in fact obvious, because of its advantages, those skilled in the art surely would have implemented it by now. That is: the fact that those skilled in the art have not implemented the invention, despite its great advantages, indicates that it is not obvious. Up to now, those skilled in the art never appreciated the advantage of the invention, although it is inherent. This is an industry that thrives on innovation and an ongoing demand for newer and better trimmer and mower models. Each year brings a new crop of machines to the market.

This is an exceedingly crowded and highly competitive field—yet nobody has done this despite the competition and what might seem obvious. If it were obvious, then it would have been done before given the need for new and novel models.

It appears that none of the prior art presented above was ever commercialized or implemented and therefore should be construed narrowly.

Although our research has uncovered no suggestions in the prior art that might anticipate our solution, any such invention that may possibly have been suggested by prior art is likely many years old by now and has never been implemented.

### Shortcomings of Other Solutions

We believe this product is clearly novel since there are no identical machines operating anywhere in the world, nor are there any comparable patents for such, or even articles suggesting the same combination of elements. There are foreign 240 volt mains-driven hover mowers, but no US 120 voltage hover machines of any type (except for our prototype); no foreign or domestic battery-driven air-supported machines of any type and we have discovered no anticipation for same.

Any prior art was never commercialized or implemented and therefore should be construed narrowly.

While on this subject, it is worthwhile to comment on the subjects of unobviousness as well as novelty. Since these tests are quintessential components of patentability, the inventors of this product wish to make some observations in that regard, specifically vis-à-vis “persons skilled in the art.”

The above patents illustrate the long felt but unfulfilled need for a trimming device that alleviates fatigue in a less capable operator and also provides a stable horizontal cutting head so that trimmer use on the lawn makes an even cut without gouging the grass. Their lack of commercial success indicates that they fall short of the goal. This militates against a finding of obviousness.

Long felt but unsolved needs, [and] failure of others” (Graham v. John Deere Co., 383 U.S. at 17, 148 USPQ at 467), are a strong factor in the evaluation of obviousness, as are improvements made in a crowded field. The current invention solves a long-felt, long-existing, but unsolved need.

In Extreme Networks v. Enterasys Networks (Fed. Cir. 2010) the Court of the Appeals for the Federal Circuit recently issued a decision that clearly narrows the definition of who is a person of ordinary skill in the art. General experience in a related field may not suffice when experience and skill in specific product design are necessary to resolve patent issues. See, e.g., Flex-Rest, LLC v. Steelcase, Inc., 455 F.3d 1351, 1360-61 (Fed. Cir. 2006) (affirming exclusion of an ergonomics expert where the invention at issue related to an ergonomic keyboard design).

The disciplines of mowers and trimmers are very different and the technology and marketing involve processes and persons of different skill sets. Mowers are almost always sturdy 4-wheeled machines that weigh and cost more than trimmers—and they typically employ steel cutting blades. Trimmers are single stick implements that invariably weigh and cost much less, and they use cutting lines rather than blades. Engineers involved in mower design, and only mowers have used air-cushioned technology until this point, are not involved in trimmer design and would therefore not qualify as persons skilled in the art under the above ruling.

In short, mowers and trimmers are in practice unconnected technical fields, so that air-supported development in the mower field does not naturally carry over into the trimmer domain. A trimmer is not a related field to a mower.

In addition, it is important to differentiate who in the major garden-care manufacturing companies, whence almost all research and innovation in this industry emanates, would be the person to whom this designation would refer. Our personal experience of mower and trimmer manufacturers across the United States and Europe indicates that the marketing managers fall into this specific category and interest area. These persons usually have a significant engineering background and knowledge because their job is to compete with other brands by offering innovative, or more efficient, or more effective tools, yet they are constrained by their engineering and manufacturing capabilities, not only of their own company but of the industry generally.

We have found from personal research and experience in this industry that the “backroom engineers” do not innovate in a vacuum but rather respond to the requests of the marketing department for a “better widget.” We therefore dismiss mower and trimmer engineers, in compartmentalized corporate divisions, as being skilled in the art that might dream up or anticipate a product combination along the lines we have invented. If asked to make one, they could probably figure out a way, but the fact is that no company in North America has yet to do so; or anywhere else in the world, for that matter.

We conclude it is difficult to establish just who is a person of ordinary skill in the art in this field.

For example, in the case of a claim to a combination, applicants may submit evidence or argument to demonstrate that:

(A) one of ordinary skill in the art could not have combined the claimed elements by known methods (e.g., due to technological difficulties);
(B) the elements in combination do not merely perform the function that each element performs separately; or
(C) the results of the claimed combination were unexpected.

The inventors suggest that the innovators in the trimmer and mower divisions were not in a position to understand the ramifications and advantages of combining the elements utilized in this application. Moreover, until very recently, the battery power in the requisite footprint and weight ratio was not sufficiently advanced for a realization of the expected results of this combination and this constitutes such a “technological difficulty” as enumerated in (A) above.

The field of mowers and trimmers is a crowded art. This invention is classified in a crowded art and, therefore, the inventors submit that a small step forward should be regarded as significant.

It is the crossover technology that makes this invention unique and unobvious. A person skilled in the art means that he or she is skilled in the particular field. That field is one but not necessarily more than one of the preceding skills sets.

Accordingly the reader will see that, according to at least one embodiment of the invention, we have provided a unique, novel, and unobvious approach to dealing with trimmer operator fatigue and creation of a level cutting plane. This invention is very easy to use, inexpensive to build and operate, and has a minimum number of adjustments to be made for proper use. The invention increases the safety of the operator and provides a welcome addition to a very crowded field.

### SUMMARY OF THE INVENTION

In accordance with this application, there is provided a lightweight battery-powered air-supported vegetation trimmer that is functional, novel and easy to use. In this embodiment, the combination of battery power and an innovative air-supported cutting head facilitates the use of the tool by elderly or less able-bodied users, allowing the operator to deploy the trimmer in more modes of operation that previous trimmer embodiments.

The ultra lightweight design and construction of the machine allows it to be carried to the lawn and there deployed by an operator without regard for the operator's age or strength.

The invention provides a much-needed improvement in efficiency of construction and driving power for lawn trimmers. It provides an improved engine system powered by an independent and removable battery that can be charged separately from the machine, or left in the machine and charged in situ. In the former case, several batteries can be charged and used sequentially to maintain the machine in indefinite motion.

### OBJECTS OF THE INVENTION

It is therefore the principal object of the invention to provide an improved air-floated vegetation cutting apparatus.

Yet another object of the invention is to provide an improved air-floated lawn trimmer that is suitable for use by the senior population.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a battery-driven air-supported vegetation trimmer in accordance with a preferred embodiment of the present invention;

FIG. 2 is a perspective view of a battery-driven air-supported vegetation trimmer in accordance with an alternative embodiment of the present invention, showing an alternative design for controlling and steering the invention using a pram handle system;

FIG. 3 is a perspective view of a battery-driven air-supported vegetation trimmer in accordance with an alternative embodiment of the present invention, showing a hybrid single stick and pram handle arrangement;

FIG. 4 is an exploded view of a perspective view of the present invention seen in FIG. 1, showing the internal construction above and under the hood, including the motor, impeller and cutting line holder;

FIG. 5 is a left perspective view of the preferred embodiment of the handle control of a single stick trimmer, comprising a removable and rechargeable battery inserted into the handle of the stick;

FIG. 6 is a right perspective view of an of an alternative embodiment of the handle control of a single stick trimmer that is powered by 120 volt mains power, showing the fixed cord and receptacle for a power extension cord;

FIG. 7 is a right section view of an alternative embodiment of the handle control of a single stick trimmer, comprising a removable and rechargeable battery inserted into the handle of the stick, where said battery is too large to fit into the end of the stick as in FIG. 5; and

FIG. 8 is a right detail view of an alternative embodiment of the handle control of a single stick trimmer, comprising a removable and rechargeable battery encased within a power pack carried over the shoulder of the operator, where said battery is too heavy to fit within the integral structure of the current invention.

For purposes of clarity and brevity, like elements and components will bear the same designations and numbering throughout the Figures.

### DRAWINGS

### Reference Numerals

1 hood
2 internal air chamber
3 electric motor
3a drive shaft
4 impeller
5 cutting element
6 supporting handle
7 air apertures
8 motor cowl
10 upward facing lugs
10a pivot apertures
11 pivot pins

### DESCRIPTION OF THE PREFERRED EMBODIMENT OF THE INVENTION

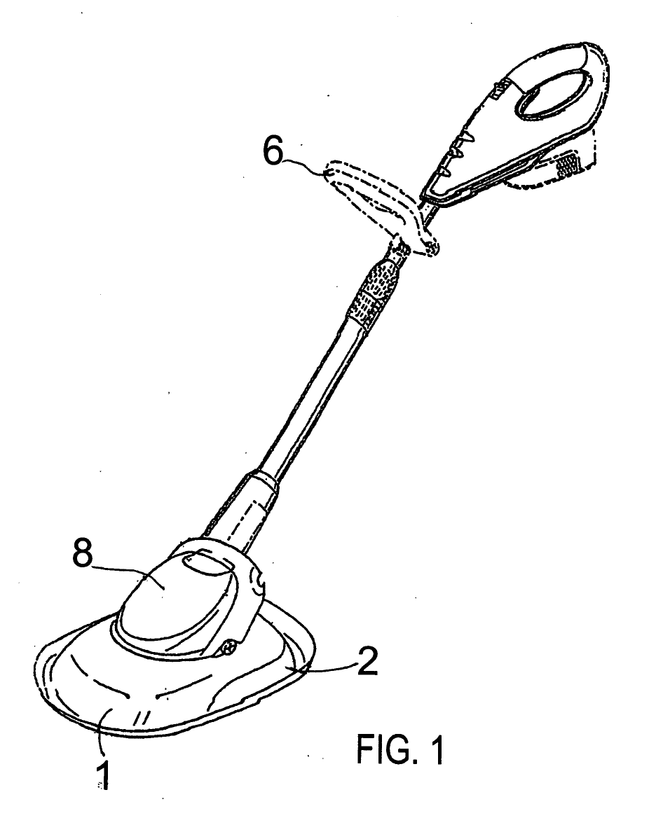

The trimmer shown in FIG. 1 of the preferred embodiment has a stick handle portion pivotably attached to a round or elliptical shaped hood (1) constructed of rigid polypropylene or other suitable plastic material, which surrounds an internal air chamber (2). The bottom sides of the hood (1) meet the ground evenly on all sides so as to create an air-tight internal chamber in order that air can be pressurized under the hood and float the trimmer off the ground to maintain a continuously horizontal cutting position above ground datum for the cutting line. The supporting handle grip (6) is movably attached to the single stick handle so that it may be adjusted by the operator into a suitable position where it can be used to balance the trimmer until the air-support lifts up the cutting head and removes weight from the operator. The handle grip (6) can also be used by the operator to create a sweeping motion of the trimmer while in use. The motor cowl (8) is removably and rotatably affixed to the hood (1) to protect the electric motor, and battery if that is situated there, and to allow the stick handle to swivel in a vertical motion through 80 degrees to allow the trimmer to cut under low branches. This model may also be driven by 120 volt mains power.

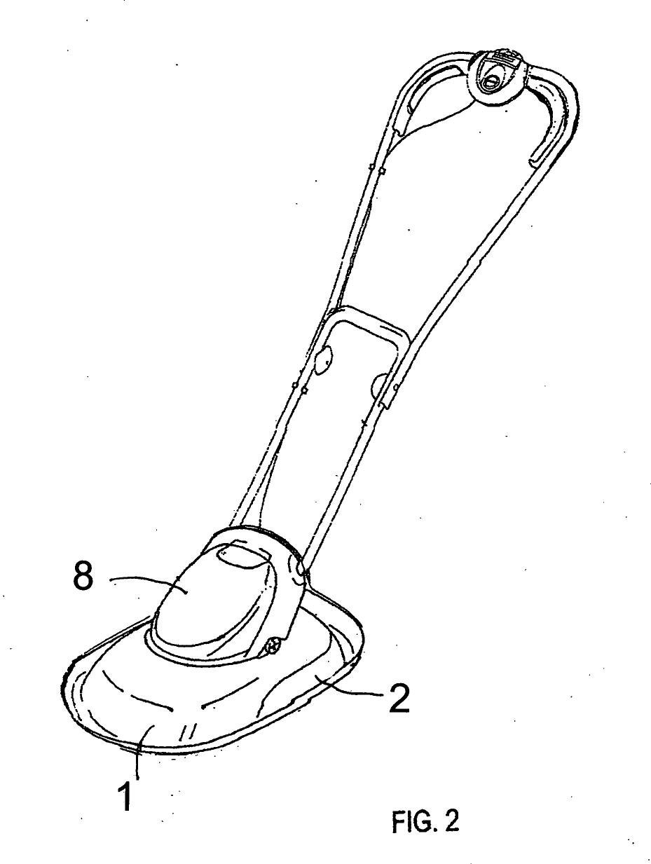

The alternative embodiment of the invention shown in FIG. 2 illustrates the identical cutting head features as in FIG. 1, except this model incorporates a pram handle embodiment similar to the type usually seen in lawn mowers. This model may be driven by 120 volt mains power or by a battery installed under the motor cowl (8). The inventors have constructed a working prototype of this model and have displayed it to major trimmer manufacturers under protection of the Provisional Patent No. 61/290,183 which this application seeks to convert to a Utility Patent. This model requires two hands to operate and steer.

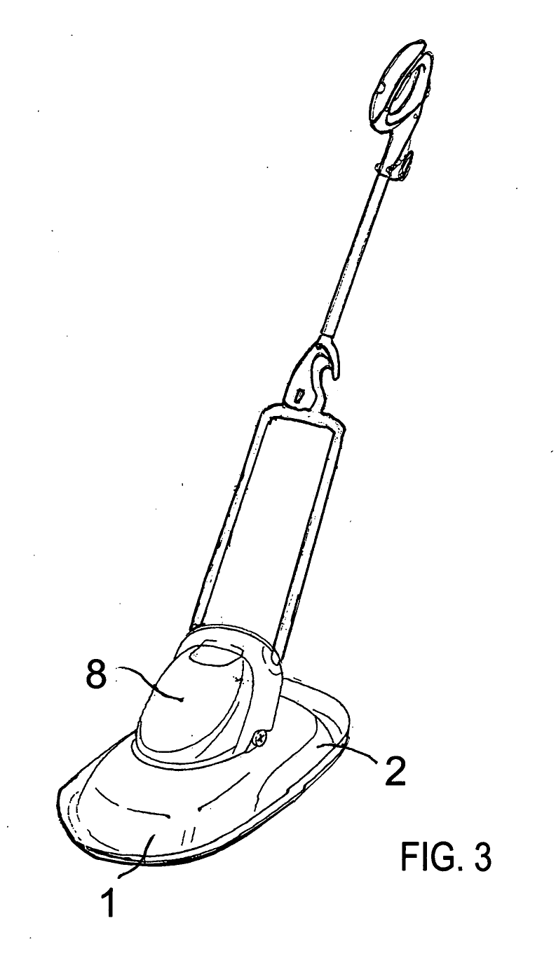

The alternative embodiment of the invention shown in FIG. 3 of the invention illustrates the identical cutting head features as in FIG. 1, except this model incorporates a hybrid handle design, using the upper half single stick design as shown in FIG. 1 and the lower half is the pram handle design of FIG. 2. This model may be driven by 120 volt mains power or by a battery installed under the motor cowl (8). This model may be operated and guided by one hand.

FIG. 4 of the invention is a cross section view of the components that make up the cutting head assembly. As previously explained under FIG. 1, the hood (1) rigidly surrounds an internal air chamber (2). The electric motor (3) is preferably a permanent magnet DC electric motor driven by an onboard battery but alternatively it may be a 120 volt AC motor connected to a mains power supply, and said motor is rigidly attached to the top of hood (1). Under power, the motor revolves at a speed in the 6500 to 8000 rpm range. The drive shaft (3a) is rotably driven by the motor (3) as it extends through the hood (1) into the internal air chamber (2) to drive the air supply impeller (4) and cutting apparatus. The impeller (4) is an upwards facing circle of rigid plastic material, comprising curved vanes that, when the impeller (4) is rotatably turned by the motor (3) by means of the drive shaft (3a), create an airflow which flows at high speed around the internal air chamber (2) and creates a pressurized cushion of air which causes the trimmer to rise off the ground. The cutting element (5) is similarly attached rigidly to the drive shaft (3a) and spins with the impeller (4) to create a vegetation cutting device. The cutting element (5) may be preferably constructed of a device holding 2 or 4 diametrically opposed cutting lines of monofilament or suitable nylon composition, or alternatively a similar arrangement using plastic blades. The impeller (4) spins at the same speed as the vegetation cutting element. The vanes of the spinning impeller (4) create a vortex of air that draws in outside air through the air apertures (7), and pressurizes the air that seeks to escape the internal air chamber (2) at its lowest edges where the hood (1) meets the ground, thereby raising the trimmer slightly off the ground datum in an equal amount on all sides, resulting in the so-called “ground effect.” The vortex of air thus created spins the cut vegetation around the internal air chamber (2) where it is cut again and again by the cutting element (5). In this manner the cut vegetation is thoroughly cut up to provide a mulching operation.

The cutting element (5) can be removed from the drive shaft (3a) and replaced upside down on the drive shaft (3a), by which means the height of the cutting element (5) above ground datum can be raised or lowered in order to cut long or short vegetation.

The air apertures (7) are affixed in a plastic structure on the top of the hood (1) to allow outside air to be drawn down into the internal air chamber (2) by the action of the impeller (4) where said air becomes the pressurized air cushion. The upstanding lugs (10) are rigidly affixed to the top of the hood and contain pivot apertures (10a) that provide for the insertion of pivot pins (11) that rotatably secure the handle to the hood (1), in a manner that allows for upward and downward motion of the handle relative to the hood.

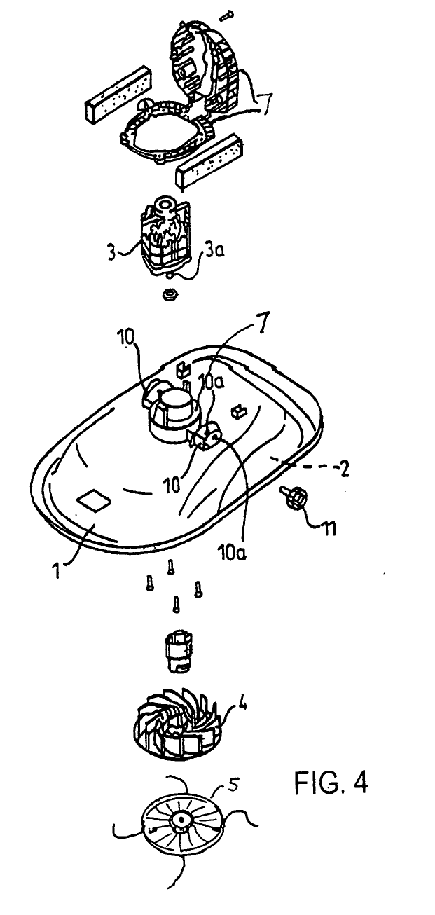

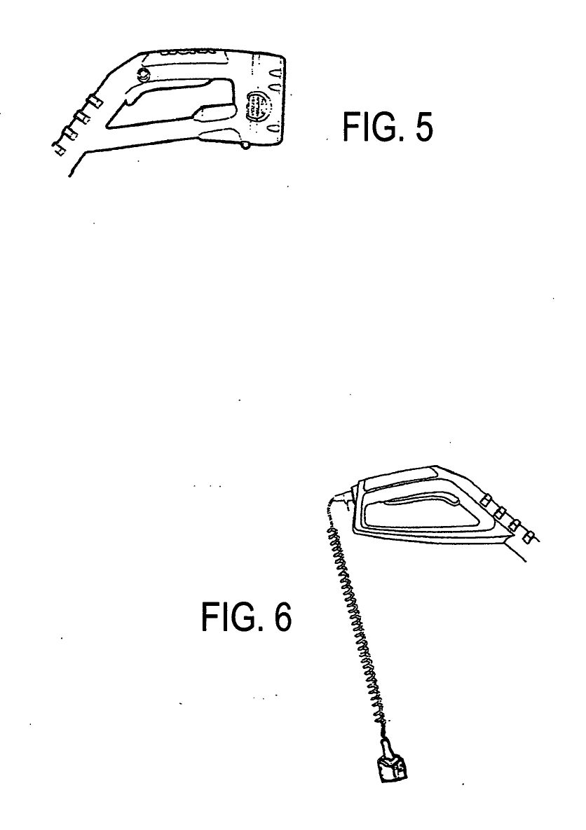

FIG. 5 is a left perspective view of the preferred embodiment of the handle control of a single stick trimmer, comprising a removable and rechargeable battery inserted into the handle of the stick. The actual configuration will vary with the size and design of the battery utilized and although this is the current shape and appearance of 12 and 18 volt batteries, higher power batteries such as the Stihl 36 volt system, are now available in a similar arrangement.

FIG. 6 illustrates the right perspective of an alternative embodiment of the handle control of a single stick trimmer that is powered by 120 volt mains power, showing the fixed cord and receptacle for a power extension cord.

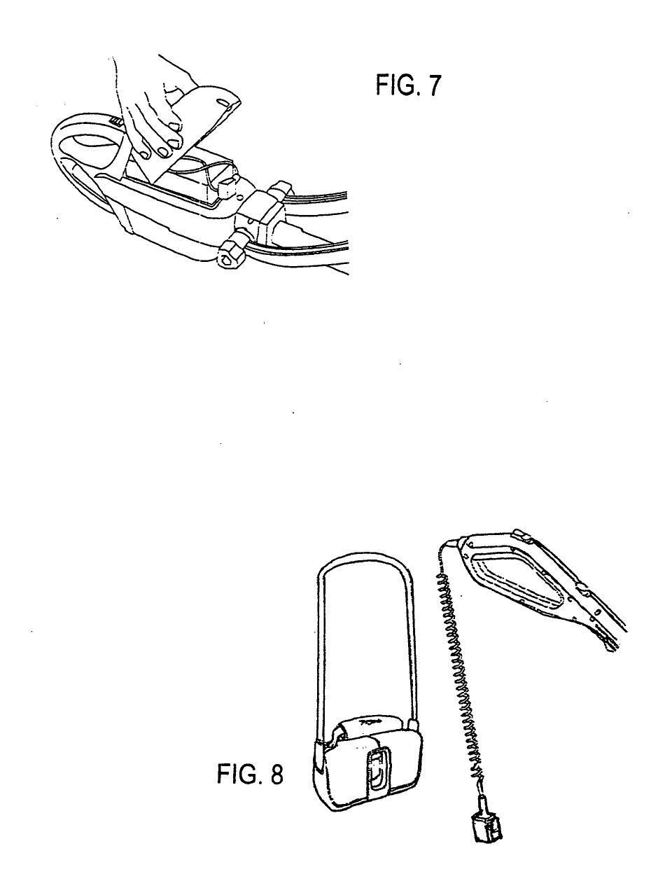

FIG. 7 is a right sectional view of an alternative embodiment of the handle control of a single stick trimmer, comprising a removable and rechargeable battery inserted into the handle of the stick, where said battery is too large to fit into the end of the stick as in FIG. 5. This configuration is designed to house 24-volt and 36-volt batteries, although innovative batteries such as the latest AP 80 Lithium-Ion battery from Stihl may not require so much space.

FIG. 8 shows the right detail of an alternative embodiment of the handle control of a single stick trimmer, comprising a removable and rechargeable battery encased within a power pack carried over the shoulder of the operator, where said battery is too heavy to fit within the integral structure of the current invention.

Since other modifications and changes varied to fit particular operating requirements and environments will be apparent to those skilled in the art, the invention is not considered limited to the examples chosen for purposes of disclosure, and covers all changes and modifications which do not constitute departures from the true spirit and scope of this invention.

Having thus described the invention, what is desired to be protected by Letters Patent is presented in the subsequently appended claims.

### CONCLUSION, RAMIFICATIONS and SCOPE

This application is for a Green Technology innovation with a low carbon footprint. This application relates to an environmentally friendly garden equipment device, specifically a grass cutting machine and in particular to an air-supported trimmer. Because this invention combines previous components with new results, it is different from every single item in this field. Because of its creative design and focus on a specific end-market, the invention is highly useful and very safe.

The aim of the invention is to provide an ultra-lightweight air-supported trimmer which is easier to use and to maneuver than known lightweight trimmers. The enclosed cutting chamber design is far safer than the open nature of the cutting shield in known trimmers.

This invention relates to a grass cutting machine and in particular to a trimmer. The current invention is an amalgam of a battery-operated trimmer shaft and controls, together with a hover cutting unit that comprises an electric motor, an impeller device for raising the trimmer above ground datum and keeping it level to the grass, with a cutting wheel or disc that revolves at variable heights below the impeller. This is a novel use of the equipment components involved and is not readily obvious to a person having ordinary skill in the area of technology related to the invention.

This invention relates generally to lawn trimmers and, more particularly to rotary lawn trimmers having one or more cutting blades mounted for rotation during operation about a generally vertical axis.

An air-supported trimmer is a grass cutting machine of the type having a cutting system which is rotatable about an axis which is substantially vertical relative to ground datum, and which is supported over ground datum by a cushion of air generated by an impeller.

Although the description contained herein contains many specificities, these should not be construed as limiting the scope of the embodiments but as merely providing illustrations of some of the presently preferred embodiments.

Thus the scope of the embodiments should be determined by the appended claims and their legal equivalents rather than by the examples given.

What is claimed is:

1. A lightweight battery-driven air-supported vegetation trimmer for providing an improved air-floated lawn trimmer or mower that reduces early fatigue for the user and is suitable for operation by persons of limited physical abilities, i.e. elderly and handicapped, comprising:
means for creating an air-tight internal chamber so that air can be pressurized under the hood and float the trimmer off the ground to maintain a continuously horizontal cutting position above ground datum for the cutting line;
means for capturing the pressurized air to float the trimmer and remove the weight load from the operator, rigidly connected to said means to create an air-tight internal chamber so that air can be pressurized under the hood and float the trimmer off the ground to maintain a continuously horizontal cutting position above ground datum for the cutting line;
means for protecting the electric motor and battery if that is situated there, flexibly connected to said means to create an air-tight internal chamber so that air can be pressurized under the hood and float the trimmer off the ground to maintain a continuously horizontal cutting position above ground datum for the cutting line;
means for driving the impeller to create pressurized air below the hood to create a hover ground effect and also to rotate the cutter element, flexibly connected to said means to protect the electric motor and battery if that is situated there, and rigidly connected to said means to create an air-tight internal chamber so that air can be pressurized under the hood and float the trimmer off the ground to maintain a continuously horizontal cutting position above ground datum for the cutting line;
means for connecting the motor and the impeller and cutter element, rotatably connected to said means to drive the impeller to create pressurized air below the hood to create said hover ground effect and also to rotate the cutter element;
means for generating a cushion of air below the hood that lifts the trimmer off the ground and maintains the cutting head in a continuously horizontal cutting position above ground datum, rigidly connected to said means to connect the motor and the impeller and cutter element, and radially connected to said means to capture the pressurized air to float the trimmer and remove the weight load from the operator;
means for holding cutting lines or blades, preferably 2 or 4 diametrically opposed monofilament or other suitable lines or hardened plastic blades, removably connected to said means to generate a cushion of air below the hood that lifts the trimmer off the ground and maintains the cutting head in a continuously horizontal cutting position above ground datum, and radially connected to said means to capture the pressurized air to float the trimmer and remove the weight load from the operator;
means for allowing air to be drawn into the internal chamber to be pressurized and create lift, rigidly connected to said means to create an air-tight internal chamber so that air can be pressurized under the hood and float the trimmer off the ground to maintain a continuously horizontal cutting position above ground datum for the cutting line;
means for supporting pivot connections so that handle may be attached to hood in such a way that the handle may be pivoted in a general vertical plane of about 80 degrees, rigidly connected to said means to create an air-tight internal chamber so that air can be pressurized under the hood and float the trimmer off the ground to maintain a continuously horizontal cutting position above ground datum for the cutting line;
means for providing support for pivot pins to attach handle to hood, rigidly connected to said means to create an air-tight internal chamber so that air can be pressurized under the hood and float the trimmer off the ground to maintain a continuously horizontal cutting position above ground datum for the cutting line; and
means for connecting handle to hood for ease of pivoting, removably connected to said means for providing support for pivot pins to attach handle to hood.

2. The lightweight battery-driven air-supported vegetation trimmer in accordance with claim 1, wherein said means to create an air-tight internal chamber so that air can be pressurized under the hood and float the trimmer off the ground to maintain a continuously horizontal cutting position above ground datum for the cutting line comprises a polypropylene or other suitable plastic, round or elliptical hood.

3. The lightweight battery-driven air-supported vegetation trimmer in accordance with claim 1, wherein said means to capture the pressurized air to float the trimmer and remove the weight load from the operator comprises a shape similar to the hood internal chamber.

4. The lightweight battery-driven air-supported vegetation trimmer in accordance with claim 1, wherein said means to protect the electric motor and battery if that is situated there comprises a motor cowl.

5. The lightweight battery-driven air-supported vegetation trimmer in accordance with claim 1, wherein said means to drive the impeller to create pressurized air below the hood to create the hover ground effect and also to rotate the cutter element comprises a battery-driven or 120 volt mains power-driven electric motor.

6. The lightweight battery-driven air-supported vegetation trimmer in accordance with claim 1, wherein said means to connect the motor and the impeller and cutter element comprises an impeller and cutter element drive shaft.

7. The lightweight battery-driven air-supported vegetation trimmer in accordance with claim 1, wherein said means to generate a cushion of air below the hood that lifts the trimmer off the ground and maintains the cutting head in a continuously horizontal cutting position above ground datum comprises a hardened plastic material upwards facing impeller.

8. The lightweight battery-driven air-supported vegetation trimmer in accordance with claim 1, wherein said means for holding cutting lines or blades, preferably 2 or 4 diametrically opposed monofilament or other suitable lines or hardened plastic blades comprises a hardened plastic cutter element.

9. The lightweight battery-driven air-supported vegetation trimmer in accordance with claim 1, wherein said means for allowing air to be drawn into the internal chamber to be pressurized and create lift comprises air apertures.

10. The lightweight battery-driven air-supported vegetation trimmer in accordance with claim 1, wherein said means for supporting pivot connections so that handle may be attached to hood in such a way that the handle may be pivoted in a general vertical plane of about 80 degrees comprises upstanding lugs.

11. The lightweight battery-driven air-supported vegetation trimmer in accordance with claim 1, wherein said means for providing support for pivot pins to attach handle to hood comprises pivot apertures.

12. The lightweight battery-driven air-supported vegetation trimmer in accordance with claim 1, wherein said means for connecting handle to hood for ease of pivoting comprises pivot pins.

13. A lightweight battery-driven air-supported vegetation trimmer for providing an improved air-floated lawn trimmer or mower that reduces early fatigue for the user and is suitable for operation by persons of limited physical abilities, i.e. elderly and handicapped, comprising:
a polypropylene or other suitable plastic, round or elliptical hood, to create an air-tight internal chamber so that air can be pressurized under the hood and float the trimmer off the ground to maintain a continuously horizontal cutting position above ground datum for the cutting line;
a shape similar to the hood internal chamber, to capture the pressurized air to float the trimmer and remove the weight load from the operator, rigidly connected to said hood;
a motor cowl, to protect the electric motor and battery if that is situated there, flexibly connected to said hood;
a battery-driven or 120 volt mains power-driven electric motor, to drive the impeller to create pressurized air below the hood to create the hover ground effect and also to rotate the cutter element, flexibly connected to said motor cowl, and rigidly connected to said hood;
an impeller drive and cutter element drive shaft, to connect the motor and the impeller and cutter element, rotatably connected to said electric motor;
a hardened plastic material upwards facing impeller, to generate a cushion of air below the hood that lifts the trimmer off the ground and maintains the cutting head in a continuously horizontal cutting position above ground datum, rigidly connected to said drive shaft, and radially connected to said internal chamber;
a hardened plastic cutter element, for holding cutting lines or blades, preferably 2 or 4 diametrically opposed monofilament or other suitable lines or hardened plastic blades, removably connected to said upwards facing impeller, and radially connected to said internal chamber;
air apertures, for allowing air to be drawn into the internal chamber to be pressurized and create lift, rigidly connected to said hood;
upstanding lugs, for supporting pivot connections so that handle may be attached to hood in such a way that the handle may be pivoted in a general vertical plane of about 80 degrees, rigidly connected to said hood;
pivot apertures, for providing support for pivot pins to attach handle to hood, rigidly connected to said hood; and
pivot pins, for connecting handle to hood for ease of pivoting, removably connected to said pivot apertures.

14. The lightweight battery-driven air-supported vegetation trimmer as recited in claim 13, further comprising:
an aluminum or suitable plastic material supporting handle, to balance the trimmer until the air-support lifts off and removes weight from the operator, rotatably connected to said hood.

15. The lightweight battery-driven air-supported vegetation trimmer as recited in claim 13, wherein said motor cowl is polypropylene or other suitable plastic.

16. A lightweight battery-driven air-supported vegetation trimmer for providing an improved air-floated lawn trimmer or mower that reduces early fatigue for the user and is suitable for operation by persons of limited physical abilities, i.e. elderly and handicapped, comprising:
a polypropylene or other suitable plastic, round or elliptical hood, to create an air-tight internal chamber so that air can be pressurized under the hood and float the trimmer off the ground to maintain a continuously horizontal cutting position above ground datum for the cutting line;
a shape similar to the hood internal chamber, to capture the pressurized air to float the trimmer and remove the weight load from the operator, rigidly connected to said hood;
a polypropylene or other suitable plastic motor cowl, to protect the electric motor and battery if that is situated there, flexibly connected to said hood;
an aluminum or suitable plastic material supporting handle, to balance the trimmer until the air-support lifts off and removes weight from the operator, rotatably connected to said hood;
a battery-driven or 120 volt mains power-driven electric motor, to drive the impeller to create pressurized air below the hood to create the hover ground effect and also to rotate the cutter element, flexibly connected to said motor cowl, and rigidly connected to said hood;
an impeller drive and cutter element drive shaft, to connect the motor and the impeller and cutter element, rotatably connected to said electric motor;
a hardened plastic material upwards facing impeller, to generate a cushion of air below the hood that lifts the trimmer off the ground and maintains the cutting head in a continuously horizontal cutting position above ground datum, rigidly connected to said drive shaft, and radially connected to said internal chamber;
a hardened plastic cutter element, for holding cutting lines or blades, preferably 2 or 4 diametrically opposed monofilament or other suitable lines or hardened plastic blades, removably connected to said upwards facing impeller, and radially connected to said internal chamber;
air apertures, for allowing air to be drawn into the internal chamber to be pressurized and create lift, rigidly connected to said hood;
hardened plastic material upstanding lugs, for supporting pivot connections so that handle may be attached to hood in such a way that the handle may be pivoted in a general vertical plane of about 80 degrees, rigidly connected to said hood;
pivot apertures, for providing support for pivot pins to attach handle to hood, rigidly connected to said hood; and
pivot pins, for connecting handle to hood for ease of pivoting, removably connected to said pivot apertures.
